(19) United States
(12) Patent Application Publication
(10) Pub. No.: US 2014/0143056 A1
(43) Pub. Date: May 22, 2014

(54) DIGITAL SHOPPING MARKETING PLATFORM

(71) Applicant: GROCERY SHOPPING NETWORK, INC., Minneapolis, MN (US)

(72) Inventor: John G. Gaughan, Buffalo, MN (US)

(73) Assignee: GROCERY SHOPPING NETWORK, INC., Minneapolis, MN (US)

(21) Appl. No.: 14/083,835

(22) Filed: Nov. 19, 2013

Related U.S. Application Data
(60) Provisional application No. 61/728,087, filed on Nov. 19, 2012.

(51) Int. Cl. G06Q 30/02

(52) U.S. Cl. CPC G06Q 30/0257
USPC 705/14.55

(57) ABSTRACT

A method of providing a digital shopping marketing platform is provided. The method includes: igniting a flash box that takes over control of the media site upon access of a media site by a user; providing at least one brand in the flash box for the user to select from; and taking over brand advertisement on the media site based on the brand selected.

### CROSS-REFERENCE TO RELATED APPLICATIONS

This Application claims priority to U.S. Provisional Application Ser. No. 61/728,087, same title herewith, filed on Nov. 19, 2012, which is incorporated in its entirety herein by reference.

### BACKGROUND

Providing select information to consumers via interactive web page is an important tool to advertisers of products and services. The more the advertisement can be directed to the specific consumer's wants and needs, the more effective the advertisement will be.

For the reasons stated above and for other reasons stated below which will become apparent to those skilled in the art upon reading and understanding the present specification, there is a need in the art for an effective and efficient method of presenting select directed advertisement to a specific consumer.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a method of providing a digital shopping marketing platform is provided. The method includes: igniting a flash box that takes over control of the media site upon access of a media site by a user; providing at least one brand in the flash box for the user to select from; and taking over brand advertisement on the media site based on the brand selected.

In yet another embodiment, a method of providing a digital shopping marketing platform is provided. The method includes: igniting a flash box that takes over control of the media site upon access of a media site by a communication device of a user; providing a plurality of sponsors in the flash box for the user to select from; and providing advertising information relating to the sponsor's product line to the user's communication device based on a selection of a sponsor. In still another embodiment a computer-readable medium having computer executable instructions for performing a digital shopping marketing platform method is provided. The method includes: igniting a flash box that takes over control of a media site upon access of the media site by a communication device of a user; providing a plurality of sponsors in the flash box for the user to select from; and providing advertising information relating to a sponsor's product line to the user's communication device based on a selection of a sponsor.

### BRIEF DESCRIPTION OF THE DRAWINGS

The present invention can be more easily understood and further advantages and uses thereof will be more readily apparent, when considered in view of the detailed description and the following figures in which:

FIG. 1 is an example screen shot of the shopper welcome (SW) of one embodiment of the present invention;

FIG. 2 illustrates a consumer pathway SW flow diagram of one embodiment of the present invention;

FIG. 3 is a screen shot of a selected brand taking over a user session of one embodiment of the present invention;

FIG. 4A is another example screen shot of a SW of one embodiment of the present invention;

FIG. 4B is a screen shot of a selected brand from FIG. 4A taking over a user session of one embodiment of the present invention;

FIG. 5 is a shopper welcome construction flow diagram of one embodiment of the present invention;

FIG. 6 is a chain configuration flow diagram of one embodiment of the present invention;

FIG. 7 is a chain offer flow diagram of one embodiment of the present invention; and

FIG. 8 is a communication system of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a method of presenting product offers to digital shopping intenders (DSI) that the DSI find valuable. DSI are online users viewing media sites. Embodiments of the present invention present the DSI with a custom message platform called a Shopper Welcome (SW). The SW, through multiple retail promotion opportunities, allows retailers to promote internal digital marketing initiatives including store brands, store specials, newsletters and loyalty card sign ups and other programs that are focused on engaging the DSI and increasing sales and shopper loyalty. The SW allows the user to choose or select information on products they find valuable. Embodiments provide shopper value messages through the SW platform as they begin the digital shopping session. Also the SW, in embodiments, allows a retail partner the opportunity to bring shopping planner values through channels within the SW that have been constructed to house these retailer specific shopper values. Embodiments of the SW also present the DSI one or more brands which the DSI can select between. In one embodiment, when the DSI selects a brand, a consumer package goods (CPG) manufacturer takes over ads presented to the DSI in the SW. In other embodiments, a retail brand takes over the presentation of brand ads.

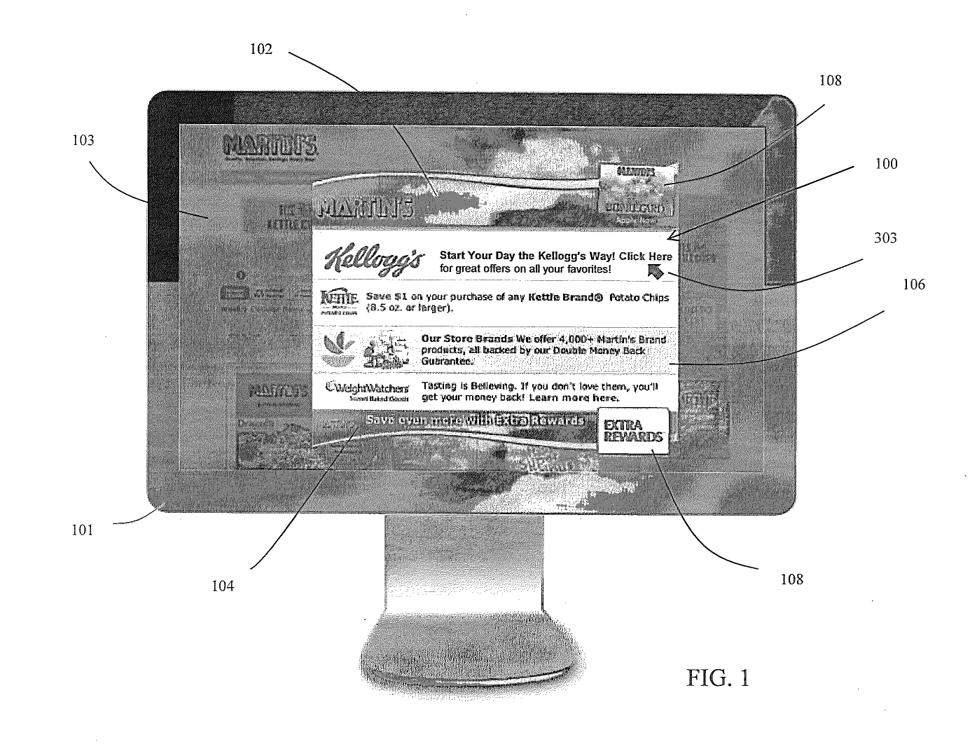

The SW includes a pop up, custom or Interactive Advertisement Bureau (IAB) standard advertising unit, or the like, generally referred to as a flash box, that is ignited when a DSI visits a particular media site. The SW includes marketing channels that accomplish specific objectives. Once engaged, the user session is surrounded exclusively by the company/brand/product/offer the DSI is interested in. If the DSI selects a “no thanks,” “skip” or any other opt out of the flash box, the DSI is sent back to the standard message platform (ad server) on the media site. An example SW 100 taking over a media site 103 on a DST's display 101 is illustrated in FIG. 1. This SW 100 embodiment includes a header 102 and footer 104. Between the header 102 and the footer 104 is a center section 106 that includes one or more offer/brands/products/companies advertisement sections. Any number of advertisement sections can be included in the center section. The SW 100 can also include specific retail promotion opportunities 108 (called digital marketing objectives) such as, but not limited to, loyalty cards, store events, shopper bonuses, etc.

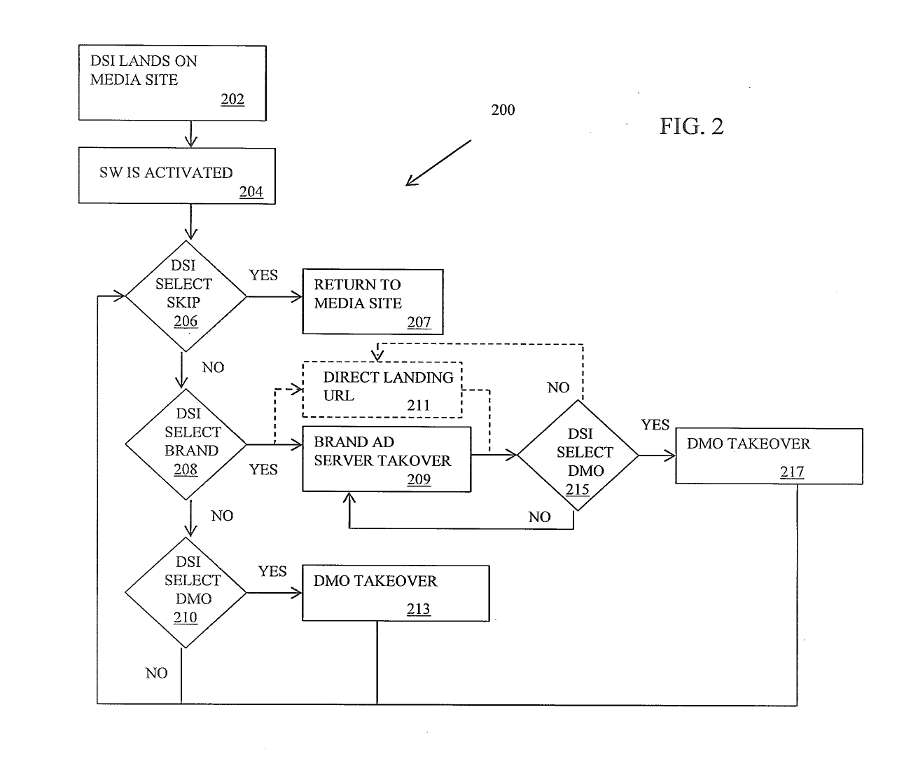

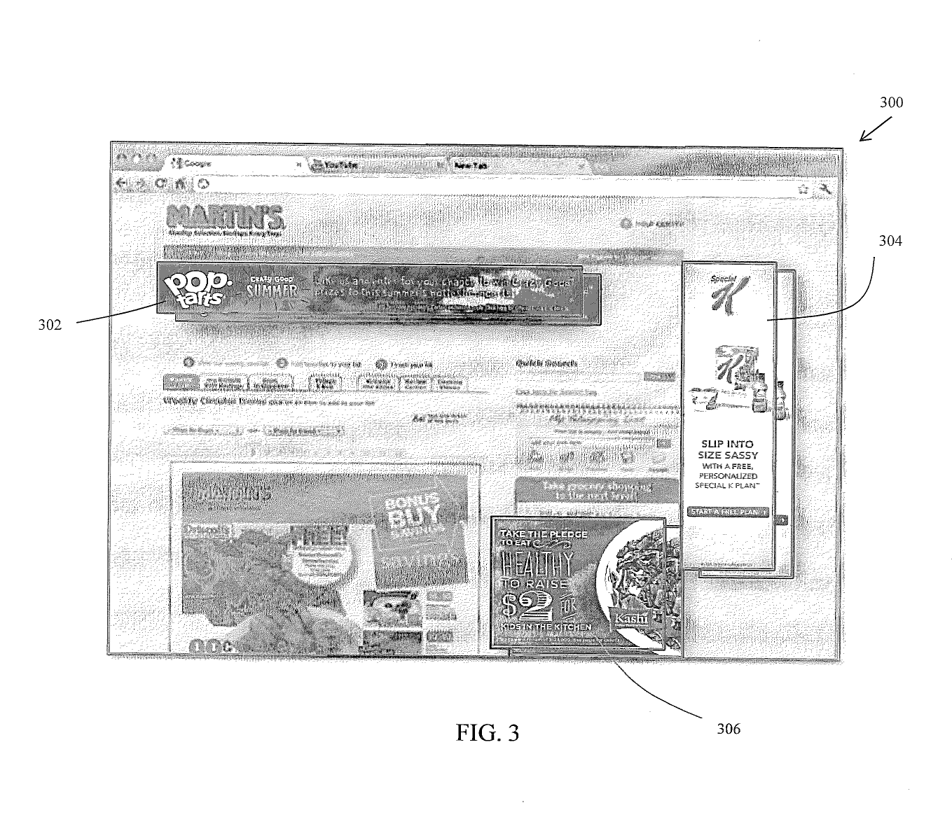

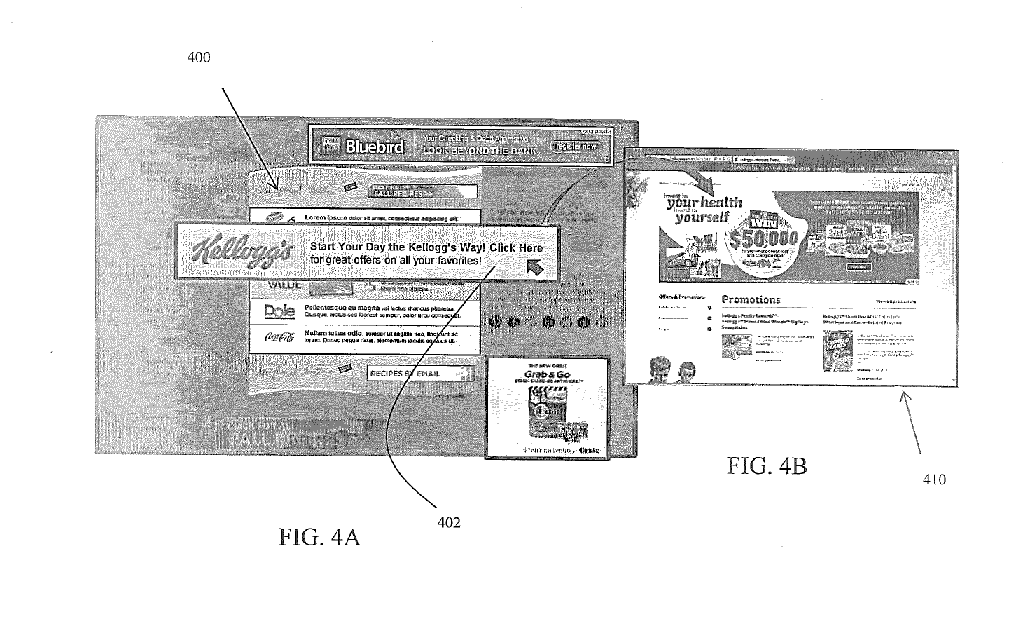

Referring to FIG. 2, a consumer pathway SW flow diagram 200 of an embodiment is illustrated. The consumer pathway SW flow diagram 200 starts with the DSI landing on a media site (202). The media site may be a retailer's web site, a third party's site or any type of site that provides a product or service. Moreover, the media site may be online, a mobile responsive media site or the like. Once the DSI has accessed the media site, SW is enabled (204). The SW enables the DSI to self-select the brand/offer (user session sponsor) they would like to host their online user session. An example of the SW is provided above in FIG. 1. If the DSI decides not to use the SW at (206), the DSI messaging and user session is defaulted back to the standard ad server at the media site (207). If the DSI selects a brand at (208), a session advertising take over takes place. In one embodiment, the session advertising take over is exclusively hosted by the brand (209). In this embodiment, a brand (a CPG manufacturer or sponsor) is allowed to take over the advertisement in the user session. For example, FIG. 1 illustrates the DSI selecting a brand (303) from a first party SW. A first party SW is hosted by an administrator. In this embodiment, the experience may happen on a retailer media site. FIG. 3 illustrates a screen shot 300 of the selected brand taking over the user session. As illustrated, in this embodiment, the CPG manufacture presents ads 302, 304 and 306 associated with the CPG manufacture's products in the background of the media site (which in this example is a retailer's site). In one embodiment, the brand ads are directed to the specific DSI based on such things, but not limited to, shopping history and personal characteristics. In another embodiment, the CPG manufacture does not take over the user session but the DSI is taken directly to a landing URL that the brand has provided (211). For example, FIG. 4A illustrates a SW 400 in which a brand 402 is selected. Upon selection of the brand, the DSI is directed to a landing Uniform Resource Locator (URL) 410. The URL is an address of a file located on the internet. In particular, FIGS. 4A and 4B illustrate the use of a third party SW which is hosted by third party network (affiliate partner). As discussed above, upon selection of the brand the DSI is taken directly to the landing URL as illustrated In FIG. 4B. As consumer pathway SW flow diagram 200 further illustrates, the digital marketing objective (DMO) option is provided both when the SW is activated (210) and when the DSI has selected a brand (215). In particular, when the DMO option is selected at (210), it is taken over at (213) and when the DMO is selected at (215) it is taken over at (217). The DMO is a direct link to a brand/retailer landing URL to enhance client digital marketing objectives such as, but not limited to, registrations, rewards, loyalty house brands and other loyalty type programs.

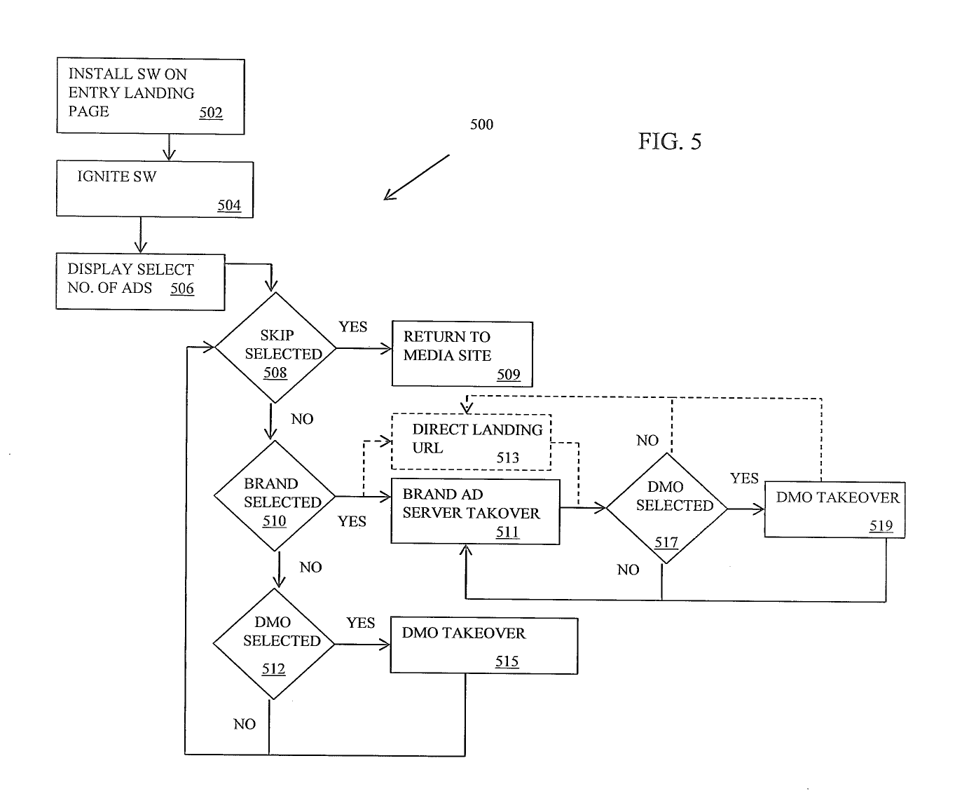

FIG. 5 illustrates a shopper welcome construction flow diagram 500 of one embodiment. As illustrated, the process starts by installing the SW on a media site such as, but not limited to, a retail media site or web publisher user entry landing page (502). It could be the home page of a retailer, a digital circular page or anywhere it is desired to have the flash box ignite. The SW is ignited when the DSI lands on the landing page (504). The SW can ignite by flash box, pop up, flash up, interstitial, custom, Interactive Advertising Bureau (IAB) standard messaging or any other method known in the art. The SW then displays the select amount of ad channels. The ad channels can include, but are not limited to, companies/brands/products/offers channels as discussed above. The number of ad channels provided on the SW can vary from one to infinity. In embodiments, various users of the SW are allowed to edit the SW as further discussed below. For example, a retailer and a CPG manufacture can provide content to the SW. If “skip” is selected at (508), the system returns the DSI to the media site (509). If the brand is selected at 510, in one embodiment, the brand server of the CPG manufacture takes over the ad session at (511). The brand server provides information relating to the brand, for example, as illustrated in FIG. 3B. The site may include DMO links as discusses above (517). If a DMO link is activated a DMO takeover 219 occurs directing the DSI to the DMO site (219). In an alternative embodiment, when a brand link is selected by the DSI, a direct landing URL to third party site is provided (513). An example of a direct landing URL is shown in FIG. 4B discussed above. The direct landing URL may also have DMO links (517) as discussed above. Also, a DMO link may be directly selected from the brand site (512). If this occurs, there is a DMO takeover (515). Once the DMO takeover is complete (i.e. the DSI has completed the task set out in the DMO), the DSI is directed back to the brand site in one embodiment.

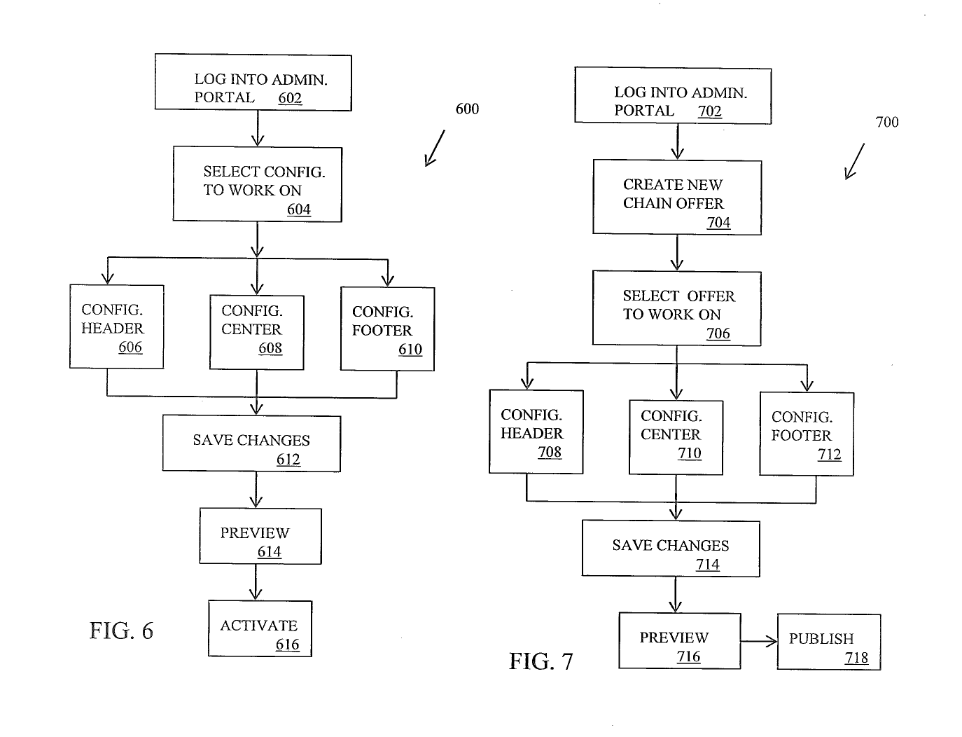

Examples of SW administrative setup are provided in the flow diagrams of FIGS. 6 and 7. In one embodiment, an administrative portal that is controlled by the operator of the media site is used for the setup. FIG. 6 illustrates a chain configuration flow diagram 600 that is used to configure the SW. As discussed above, the SW allows a retailer to promote their internal digital marketing initiatives that may include store brands, store specials, newsletters, and loyalty card sign ups, as well as third party promotion executions such as, but not limited to, “mommy blogger” internal marketing initiatives. The SW is focused on engaging the DSI, increasing sales and creating shopper loyalty. As FIG. 6 illustrates, the chain configuration is started by a user, such as a retailer, logging into an administrative portal that is operated by the administrator of the SW (602). The user then selects at (604) which chain configuration (606), (608) or (610) to work on by selecting an associated link. When configure header (606) is selected, the user is brought to an edit header screen that allows the user to edit the header. Examples of items the user can configure in the header are, but are not limited to: a logo, the font used, adding text, header background color, and header background image. An example header 102 of a SW is illustrated in FIG. 1. When configure center (608) is selected, the user is allowed to configure such options as, but not limited to: the color of the background and the color of the divider between each SW offer. An example, center 106 of SW 100 is illustrated in FIG. 1. When configure footer (610) is selected, the user is allowed to configure such options as, but not limited to: a logo, a text font, adding text, background image and background color. An example, footer 104 is illustrated in the SW 100 of FIG. 1. In an embodiment, once the header, center and footer are configured, the user simply saves the changes (612). The user can then select a preview option (614) that allows the user to preview the configuration of SW. Once the user approves the SW the user elects to click an activate button (616).

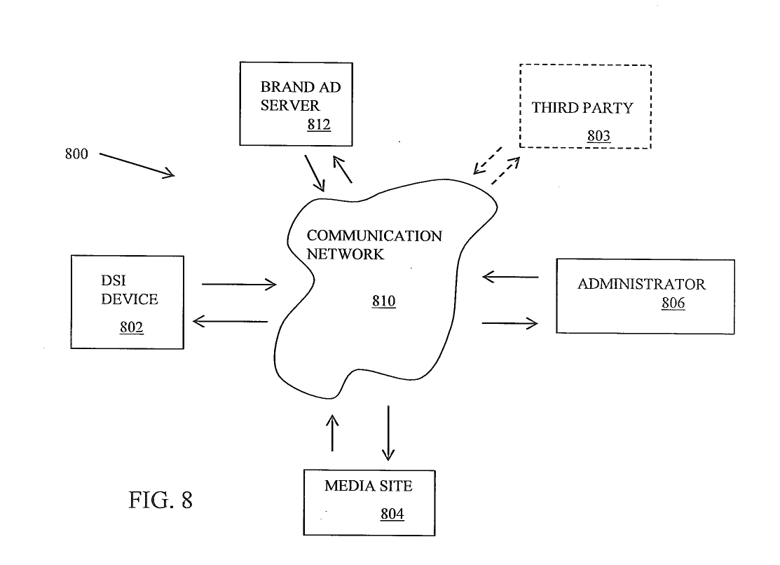

FIG. 7 illustrates a chain offer flow diagram 700 of one embodiment. It is used by the user to set up chain offers in the SW. The process starts by the user logging into an administrator portal (702). The user then creates a new chain offer (704) by selecting an “add chain offer” button or an “edit” link next to an existing offer. Chain offers include, but are not limited to, naming the campaign or using reference text. The naming of the campaign is not displayed by the SW but is used for reference. The user then selects at (706) where to set up the chain offer in the header (708), the center (710) or the footer (712). If the header is selected at (708), the user sets up such things as, but are not limited to, a start date of the header offer, an end date of the header offer, an offer image and a URL that creates a link to a webpage, picture, email address, etc relating to the offer. When the user selects the center offer at (710), the user sets up such things as a start date of the offer, an end date of the offer, the offer text, an offer image, background color if desired, and a URL link to a webpage, picture, email address etc. relating to the offer. When the user selects the footer offer (712), the user sets up such things as the start date of the offer, the end date of the offer, an offer image, offer text and a URL link to a webpage, picture, email address, etc. relating to the offer. An example offer is the retail promotion opportunities 108 illustrated in the header 102 and footer 104 of the SW 100 of FIG. 1. Once the set up is complete, the user clicks save at (714). The user can then preview the offer within the SW at (716). Once the user approves the offer the user clicks a publish button in an embodiment to activate the offer (718).
FIG. 8 illustrates a block diagram of a communication system 800 that implements the SW as discussed above in an example embodiment. The communication system includes the DSI device in which the DSI uses to communicate with the media site 804. The DSI device 802 communicates with the DSI 804 via communication network 810. The communication network 810 can include the internet, wired or wireless network or any combination thereof. An example DSI device 802 is any type of communication device that conveys information such as, but not limited to, personal computers, laptop computers, tablet computers and mobile phone devices. Such devices typically include a processor, memory and a display. The media site 804 may be generated by a retailer computer system that includes a processor and memory that stores and presents the retailer's products to the DSI via the media site. The administrator 806 provides the instructions to the media site 804 to set up the SW as well as administer the SW. In a first party SW, the administrator hosts the media site. The brand ad server 812 of the CPG manufacturer takes over the presentation of the ads in the media site 804 via activation of a brand ad on the SW. The brand ad server 812 includes at least a processor and memory to store the brand ads. Further, in another embodiment, a third party 803 is used when a brand is selected from a SW. The third party 803 includes a processor and a memory. In this third party hosted embodiment, a direct landing URL to the third party ad server is provided. Further in this embodiment, the third party 803 has access to the administrator 806 so global configuration and client offers can be configured.

As stated above, the methods and techniques described here are implemented by one or more computer systems. Embodiments of the computer systems may be implemented in digital electronic circuitry, or with a programmable processor (for example, a special-purpose processor or a general-purpose processer such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of providing a digital shopping marketing platform comprising:
upon access of a media site by a user, igniting a flash box that takes over control of the media site;
providing at least one brand in the flash box for the user to select from; and
upon selection of a brand, taking over brand advertisement on the media site based on the brand selected.

2. The method of claim 1, further comprising:
upon selection of an opt out by the user, reverting control back to the media site.

3. The method of claim 1, further comprising:
upon activation of a select digital marketing objective (DMO), linking the user to a landing uniform resource locator (URL) site.

4. The method of claim 3, wherein the URL landing site provides at least one of registrations, rewards, loyalty house brands and loyalty programs.

5. The method of claim 1, wherein the takeover of the advertisement is personalized to the user.

6. A method of providing a digital shopping marketing platform comprising:
upon access of a media site by a communication device of a user, igniting a flash box that takes over control of the media site;
providing a plurality of sponsors in the flash box for the user to select from; and
based on a selection of a sponsor, providing advertising information relating to the sponsor's product line to the user's communication device.

7. The method of claim 6, further comprising:
upon selection of an opt out by the user, reverting control back to the media site.

8. The method of claim 6, wherein the communication device is one of a personal computer, a laptop computer, a tablet computer and a mobile phone device.

9. The method of claim 6, further comprising:
upon activation of a select digital marketing objective (DMO), linking the user to a landing uniform resource locator (URL).

10. The method of claim 9, wherein the URL landing site provides at least one of registrations, rewards, loyalty house brands and loyalty programs.

11. The method of claim 6, wherein the takeover of the advertisement information is personalized to the user.

12. The method of claim 6, wherein the sponsor provides the advertising information relating to the sponsor's product line to the user's communication device.

13. The method of claim 6, wherein a third party provides the advertising information relating to the sponsor's product line to the user's communication device.

14. The method of claim 6, further comprising:
setting up the flash box.

15. The method of claim 14, wherein setting up the flash box further comprises:
logging into a portal controlled by an administrator of the flash box;
configuring the flash box; and
setting up offers in the flash box.

16. A computer-readable medium having computer executable instructions for performing a digital shopping marketing platform method comprising:
igniting a flash box that takes over control of a media site upon access of the media site by a communication device of a user;
providing a plurality of sponsors in the flash box for the user to select from; and
providing advertising information relating to a sponsor's product line to the user's communication device based on a selection of a sponsor.

17. The computer-readable medium of claim 16, the method further comprising:
reverting control back to the media site upon selection of an opt out by the user.

18. The computer-readable medium of claim 16, the method further comprising:
linking the user to a landing uniform resource locator (ULR) upon activation of a select digital marketing objective (DMO).

19. The computer-readable medium of claim 16, the method further comprising:
setting up the flash box.

20. The computer-readable medium of claim 16, the method further comprising:
configuring the flash box; and
setting up offers in the flash box.
